(19) United States
(12) Patent Application Publication
(10) Pub. No.: US 2020/0124742 A1
(43) Pub. Date: Apr. 23, 2020

(54) METHOD AND SYSTEM FOR GUIDING AN AIRCRAFT IN AN APPROACH PROCEDURE WITH A VIEW TO LANDING ON A LANDING RUNWAY

(71) Applicant: Airbus Operations SAS, Toulouse (FR)

(72) Inventor: François Tranchet, Toulouse (FR)

(21) Appl. No.: 16/596,854

(22) Filed: Oct. 9, 2019

(30) Foreign Application Priority Data
Oct. 18, 2018 (FR) 1859628

(51) Int. Cl. G01S 19/40; G01S 19/15

(52) U.S. Cl. CPC G01S 19/40; G01S 19/15

(57) ABSTRACT

A guidance system comprises a receiving module for receiving first and second pseudo-ranges sent by at least five satellites of a geopositioning system, a determining module for determining an ionospheric correction, a determining module for determining a usable pseudo-range, a determining module for determining a usable residual ionospheric error, a determining module for determining a usable standard deviation and a guiding module for guiding the aircraft from the pseudo-range of each of the at least five satellites and the usable standard deviation of each of the at least five satellites. The guidance system makes it possible to ensure the integrity of the two-frequency ionospheric corrections of the geopositioning system.

### CROSS-REFERENCES TO RELATED APPLICATIONS

This application claims the benefit of French patent application No. 1859628 filed on Oct. 18, 2018, the entire disclosures of which are incorporated herein by way of reference.

### FIELD OF THE INVENTION

The present invention relates to a method and a system for guiding an aircraft in an approach procedure with a view to landing on a landing runway.

### BACKGROUND OF THE INVENTION

The determination of the position of a receiving device, such as an aircraft, from signals sent by a satellite geopositioning system is based on propagation time measurements between at least four satellites of the geopositioning system and the receiver. The propagation measurements can be effected by different types of errors deriving, for example, from signal propagation delays dependent on the frequency carrying the signals. The use of these error-effected measurements culminates in errors in the determination of the position of the receiver. One of the main contributors of errors for determining the position of the receiver can be the signal propagation delay when the signals pass through the ionosphere.

There are various methods capable of correcting the signal propagation delays. One of the methods is suited to receivers configured to receive signals carried by a frequency made available to all the receivers. This method uses the Klobuchar model which models the ionosphere. It makes it possible to reduce the propagation delays by the order of 50%.

Another method is suited to the receivers configured to receive signals carried by two frequencies. This method uses two-frequency ionospheric corrections which almost completely eliminate the propagation delays, which provides an improvement in the determination of the position of the receiver.

However, the use of the two-frequency ionospheric corrections requires algorithms and complex implementations to ensure integrity of the navigation information of the aircraft in order to guide the aircraft, when the receiver is an aircraft. Indeed, this use necessitates, for example, the installation of satellite-based augmentation systems SBAS or the installation of advanced receiver autonomous integrity monitoring (ARAIM) devices. Furthermore, these algorithms and these implementations are not all currently available or usable.

### SUMMARY OF THE INVENTION

An object of the present invention is to mitigate these drawbacks by proposing a method and a system for guiding an aircraft in an approach procedure with a view to landing on landing runway using a satellite geopositioning system.

To this end, the invention relates to a method for guiding an aircraft in an approach procedure with a view to landing on a landing runway, using a satellite geopositioning system comprising a set of satellites.

According to the invention, the guidance method comprises the following steps implemented iteratively:

a reception step, implemented by a receiving module, comprising receiving at least one first signal carried by a first frequency and sent by at least five satellites of the geopositioning system and at least one second signal carried by a second frequency and sent by each of the at least five satellites, the first signal comprising at least one item of information representative of a first pseudo-range measured by each of the at least five satellites, the second signal comprising at least one item of information representative of a second pseudo-range measured by each of the at least five satellites,

a first determination step, implemented by a first determining module, comprising determining a first ionospheric correction for each of the at least five satellites from the first pseudo-range and the second pseudo-range measured by each of the at least five satellites,

a second determination step, implemented by a second determining module, comprising determining a usable pseudo-range for each of the at least five satellites from at least the first measured pseudo-range and the first ionospheric correction,

a third determination step, implemented by a third determining module, comprising determining a usable residual ionospheric error for each of the at least five satellites, the usable residual ionospheric error being equal to the sum of a first residual ionospheric error and the absolute value of the difference between an ionospheric correction originating from an atmospheric model and from the first ionospheric correction,

a fourth determination step, implemented by a fourth determining module, comprising determining a usable standard deviation for each of the at least five satellites from at least the usable residual ionospheric error,

a step of guidance of the aircraft, implemented by a guiding module, comprising guiding the aircraft from the usable pseudo-range of each of the at least five satellites and the usable standard deviation of each of the at least five satellites.

Thus, by virtue of the invention, the guidance method makes it possible to ensure the integrity of a two-frequency ionospheric correction determined from pseudo-ranges measured by the satellites of a geopositioning system, and a residual error that are used to determine a position of the aircraft for, for example, a vertical guidance for non-precision approaches no matter when and no matter where.

According to a particular feature, the step of guidance of the aircraft comprises the following substeps:

a first determination substep, implemented by a first determination submodule, comprising determining navigation information of the aircraft from the usable pseudo-range of each of the at least five satellites and the usable standard deviation of each of the at least five satellites,

a second determination substep, implemented by a second determination submodule, comprising determining a trajectory deviation from an approach segment and navigation information,

a guidance substep, implemented by a guidance submodule, comprising guiding the aircraft from the trajectory deviation and guidance and control laws.

Furthermore, in the first determination step, the first ionospheric correction expressed in meters is determined from the following expression:

$${IonoCorrection}_{L 1 L 5} = \frac{RAW \_ {PR}_{L5} - {γ}_{L 1 L 5} RAW \_ {PR}_{L 1}}{1 - {γ}_{L 1 L 5}}$$

in which:

RAW_PR_{L1} corresponds to the first the measured pseudo-range expressed in meters,

RAW_PR_{L5} corresponds to the second measured pseudo-range expressed in meters,

γ_{L1L5} corresponds to a predetermined constant.

Furthermore, the first signal also comprises an item of information representative of a clock correction and, in the second determination step, the usable pseudo-range expressed in meters is determined from the following expression:

PR=Smoothed(RAW_PR_{L1})+TropoCorrection+ClockCorrection+IonoCorrection_{L1L5}

in which:

Smoothed(RAW_PR_{L1}) corresponds to the first pseudo-range smoothed by the second determining module expressed in meters,

TropoCorrection corresponds to a tropospheric correction expressed in meters determined by the second determining module,

ClockCorrection corresponds to the clock correction expressed in meters, IonoCorrection_{L1L5} corresponds to the first ionospheric correction expressed in meters.

Moreover, the first signal also comprises an item of information representative of an elevation angle of the satellite sending the first signal, and, in the third determination step, the first residual ionospheric error expressed in meters is determined from the following expression:

$${IonoResidual}_{L 1 L 5} = \frac{40}{261 + {EL}^{2}} + 0.018$$

in which:

EL corresponds to the elevation angle of the satellite expressed in degrees.

Furthermore, the first signal comprises an item of information representative of a residual positioning error of the satellite sending the first signal, and, in the fourth determination step, the usable standard deviation expressed in meters is determined from the following expression:

$$σ = \sqrt{{URA}^{2} + {TropoResidual}^{2} + {IonoResidual}^{2} + {AirBorneReceiverResidual}^{2}}$$

in which:

URA corresponds to the residual positioning error expressed in meters,

TropoResidual corresponds to a residual tropospheric error expressed in meters determined by the fourth determining module,

IonoResidual corresponds to the usable residual ionospheric error expressed in meters determined in the third determination step,

AirBorneReceiverResidual corresponds to a residual thermal noise error expressed in meters.

According to another particular feature, the method also comprises a monitoring step, implemented by a monitoring module, comprising monitoring the integrity of the navigation information.

Advantageously, the first frequency carrying the first signal has a value of between 1500 MHz and 1600 MHz, and the second frequency carrying the second signal has a value of between 1170 MHz and 1180 MHz.

The invention also relates to a system for guiding an aircraft in an approach procedure with a view to landing on a landing runway, using a satellite geopositioning system comprising a set of satellites.

According to the invention, the guidance system comprises the following modules:

a receiving module configured to receive at least one first signal carried by a first frequency and sent by at least five satellites of the geopositioning system and at least one second signal carried by a second frequency and sent by each of the at least five satellites, the first signal comprising at least one item of information representative of a first pseudo-range measured by each of the at least five satellites, the second signal comprising at least one item of information representative of a second pseudo-range measured by each of the at least five satellites,

a first determining module configured to determine a first ionospheric correction for each of the at least five satellites from the first pseudo-range and the second pseudo-range measured by each of the at least five satellites,

a second determining module configured to determine a usable pseudo-range for each of the at least five satellites from at least the first measured pseudo-range and the first ionospheric correction,

a third determining module configured to determine a usable residual ionospheric error for each of the at least five satellites, the usable residual ionospheric error being equal to the sum of a first residual ionospheric error and the absolute value of the difference between an ionospheric correction originating from an atmospheric model and the first ionospheric correction,

a fourth determining module configured to determine a usable standard deviation for each of the at least five satellites from at least the usable residual ionospheric error,

a guiding module configured to guide the aircraft from the usable pseudo-range of each of the at least five satellites and the usable standard deviation of each of the at least five satellites.

According to a particular feature, the guidance system further comprises a monitoring module configured to monitor the integrity of the navigation information.

The invention also relates to an aircraft, which comprises a guidance system, as specified above.

### BRIEF DESCRIPTION OF THE DRAWINGS

The invention, with its features and advantages, will become clearer on reading the description given with reference to the attached drawings in which:

FIG. 1 schematically represents the guidance system,

FIG. 2 represents a plan view of an aircraft with the guidance system embedded in an approach procedure with a view to landing on a landing runway,

FIG. 3 represents a block diagram view of the guidance method.

### DETAILED DESCRIPTION OF THE PREFERRED EMBODIMENTS

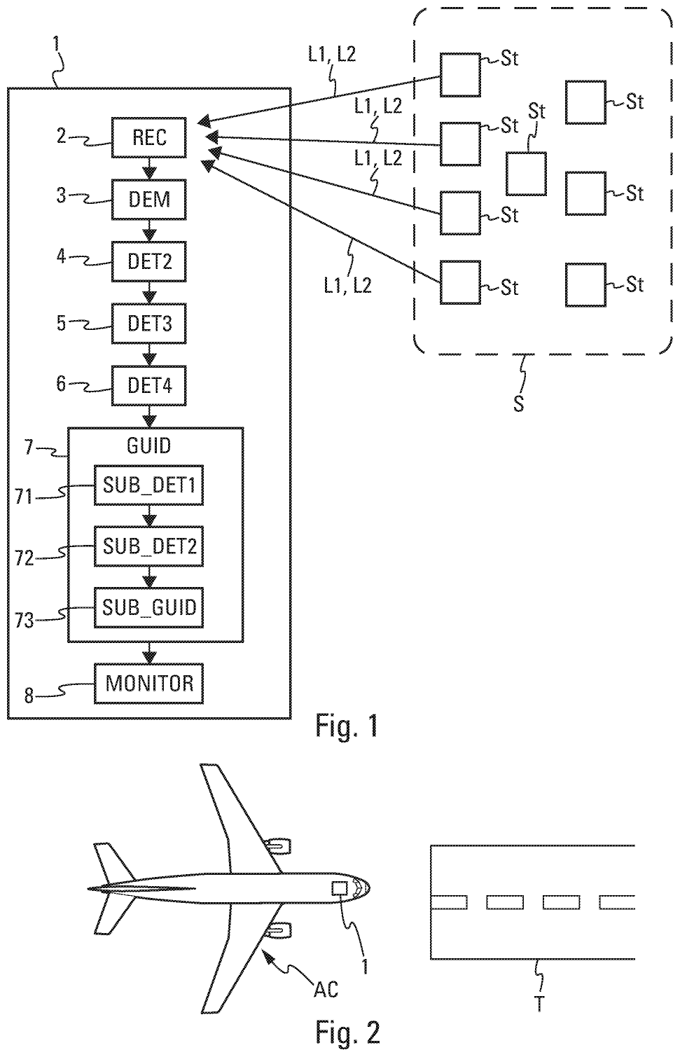

The guidance system 1 of an aircraft AC, in particular of a transport airplane, in an approach procedure with a view to landing on a landing runway T, is represented in FIG. 1. The guidance system 1, embedded on the aircraft AC, is implemented using a satellite St geopositioning system S comprising a set of satellites St (FIG. 2), such as a GPS (Global Positioning System) system. The guidance system 1 allows a navigation of the aircraft AC for approach maneuvers at altitudes that can drop to 250 feet (approximately 76 meters).

The guidance system 1 comprises a receiving module REC 2 configured to receive at least one signal L1 carried by a first frequency and sent by each of the at least five satellites St of the geopositioning system S and at least one signal L5 carried by a second frequency and sent by each of the at least five satellites St.

Preferably, the first frequency has a value of between 1500 MHz and 1600 MHz. The second frequency has a value of between 1170 MHz and 1180 MHz.

Advantageously, the first frequency has a value substantially equal to 1575.42 MHz and the second frequency a value substantially equal to 1176.45 MHz.

The signal L1 comprises an item of information representative of pseudo-range RAW_PR_{L1} measured (in meters) by each of the at least five satellites. The signal L5 comprises at least one item of information representative of a pseudo-range RAW_PR_{L5} measured (in meters) by each of the at least five satellites.

A pseudo-range measurement corresponds to an indirect measurement of range between a sending satellite St of the geopositioning system S and the guidance system 1 (comprising the receiving module 2) by comparison of the instant of reception of a signal received by the guidance system 1 and the instant of sending of the signal by the sending satellite St without taking into account the synchronization of the clocks of the guidance system 1 and of the sending satellite St.

The guidance system 1 also comprises a determining module DET1 3 configured to determine an ionospheric correction IonoCorrectionL1L5 for each of the at least five satellites from the pseudo-range RAW_PR_{L1} and the pseudo-range RAW_PR_{L5} measured by each of the at least five satellites.

The guidance system 1 further comprises a determining module DET2 4 configured to determine a usable pseudo-range PR for each of the at least five satellites from at least the measured pseudo-range RAW_PR_{L1} and the ionospheric correction IonoCorrection_{L1L5}.

The ionospheric correction IonoCorrection_{L1L5} can be determined from the following expression:

$${IonoCorrection}_{L 1 L 5} = \frac{RAW \_ {PR}_{L 5} - {γ}_{L 1 L 5} RAW \_ {PR}_{L 1}}{1 - {γ}_{L 1 L 5}}$$

The term γ_{L1L5} corresponds to a predetermined constant advantageously equal to

$${( \frac{154}{115} )}^{2} .$$

This expression and the following expressions are given for terms whose unit is the meter. These expressions can be adapted according to the unit used.

The usable pseudo-range PR can be determined from the following expression:

PR=Smoothed(RAW_PR_{L1})+TropoCorrection+ClockCorrection+IonoCorrection_{L1L5}

in which:

Smoothed(RAW_PR_{L1}) (in meters) corresponds to the first pseudo-range which has been smoothed by the determining module 4,

TropoCorrection (in meters) corresponds to a tropospheric correction determined by the determining module 4, and

ClockCorrection (in meters) corresponds to the clock correction.

The signal L1 received by the receiving module 2 can comprise an item of information representative of this clock correction.

The first measured pseudo-range can be smoothed from a method implemented by the determining module 4 allowing the smoothing of the series of measurements of first pseudo-ranges in order to attenuate the measurement noises.

The guidance system also comprises a determining module DET3 5 configured to determine a usable residual ionospheric error IonoResidual (in meters) for each of the at least five satellites. The usable residual ionospheric error IonoResidual is determined by the following expression:

IonoResidual=IonoResidual_{L1L5}+|IonoCorrection_{Klobuchar}−IonoCorrection_{L1L5}|

in which:

IonoCorrection_{Klobuchar} (in meters) corresponds to an ionospheric correction originating from an atmospheric model, and

IonoResidual_{L1L5} (in meters) corresponds to a first residual ionospheric error.

The atmospheric model can correspond to the Klobuchar ionospheric model.

Thus, the usable residual ionospheric error IonoResidual is equal to the sum of the residual ionospheric error IonoResidual_{L1L5} and the absolute value of the difference between the ionospheric correction originating from an atmospheric model IonoCorrection_{Klobuchar} and the ionospheric correction IonoCorrection_{L1L5}. That makes it possible to ensure the integrity of the correction IonoCorrection_{L1L5} by providing a reliable upper limit IonoResidual of the error which has not been able to be corrected by the correction IonoCorrection_{L1L5}.

The residual ionospheric error IonoResidual_{L1L5} can be determined from the following expression:

$${IonoResidual}_{L 1 L 5} = \frac{40}{261 + {EL}^{2}} + 0.018$$

in which EL (in degrees) corresponds to an elevation angle of the satellite in degrees. The signal L1 received by the receiving module 2 can comprise an item of information representative of this elevation angle of the satellite sending the signal L1.

The guidance system further comprises a determining module DET4 6 configured to determine a usable standard deviation o for each of the at least five satellites from at least the usable residual ionospheric error IonoResidual.

The usable standard deviation o can be determined from the following expression:

$$σ = \sqrt{{URA}^{2} + {TropoResidual}^{2} + {IonoResidual}^{2} + {AirBorneReceiverResidual}^{2}}$$

in which:

URA (in meters) corresponds to a residual positioning error of the satellite,

TropoResidual (in meters) corresponds to a residual tropospheric error determined by the determining module 6,

IonoResidual (in meters) corresponds to the usable residual ionospheric error computed by the determining module 5,

AirBorneReceiverResidual (in meters) corresponds to a residual thermal noise error of the receiving system, in particular of the guidance system 1. This residual thermal noise error can be determined by the determining module 6.

The signal L1 can also comprise an item of information representative of the residual positioning error URA (URA for “User Range Accuracy”) of the satellite sending the signal L1.

The guidance system comprises a guiding module GUID 7 configured to guide the aircraft AC from the usable pseudo-range PR of each of the at least five satellites and the usable standard deviation o of each of the at least five satellites.

According to one embodiment, the guiding module 7 comprises:

a determining submodule SUB)DET1 71 configured to determine navigation information PVT of the aircraft AC from the usable pseudo-range PR of each of the at least five satellites and the usable standard deviation o of each of the at least five satellites,

a determining submodule SUB_DET2 72 configured to determine a trajectory deviation from an approach segment and navigation information PVT,

a guiding submodule SUB_GUID 73 configured to guide the aircraft AC from the trajectory deviation and guidance and control laws.

The navigation information PVT corresponds to the position, to the speed of the aircraft AC at a given time. The navigation information PVT can be determined from the usable pseudo-ranges PR by the least squares method. The navigation information PVT makes it possible to plan the trajectory of the aircraft AC. This planned trajectory is compared to the approach segments. The approach segments correspond to trajectory segments which follow the ideal trajectory of landing on a landing runway T. The comparison of the planned trajectory with the approach segments makes it possible to determine a trajectory deviation. The guidance and control laws make it possible to minimize the trajectory deviation in order for the actual trajectory of the aircraft AC to approach the ideal trajectory.

The approach segments can be provided by a data base embedded in the aircraft AC.

Moreover, the guidance system 1 comprises a monitoring module MONITOR 8 configured to monitor the integrity of the navigation information PVT. The monitoring module can comprise a device for autonomously monitoring the integrity of the receiver, such as an RAIM (for “Receiver Autonomous Integrity Monitoring”) device.

Of the five satellites St of the geopositioning system S, four satellites are used to determine a position, for example the position of the navigation information PVT. The fifth satellite is used to guarantee the integrity.

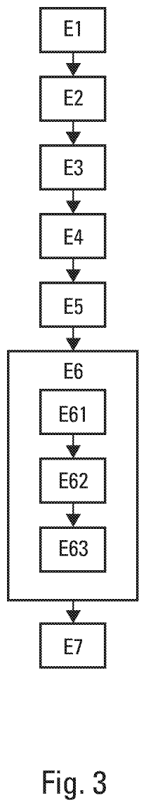

The invention also relates to a method for guiding (FIG. 3) an aircraft AC in an approach procedure with a view to landing on a landing runway, using the satellite geopositioning system S comprising a set of satellites St.

The guidance method comprises the following steps implemented iteratively.

A reception step E1, implemented by the receiving module 2, comprising receiving at least the signal L1 carried by the first frequency and sent by at least five satellites of the geopositioning system and at least the signal L5 carried by the second frequency and sent by each of the at least five satellites,

a determination step E2, implemented by the determining module 3, comprising determining the ionospheric correction IonoCorrection_{L1L5} for each of the at least five satellites from the pseudo-range RAW_PR_{L1} and the pseudo-range RAW_PR_{L5} measured by each of at least five satellites,

a determination step E3, implemented by the determining module 4, comprising determining the usable pseudo-range PR for each of the at least five satellites from at least the measured pseudo-range RAW_PR_{L1} and the ionospheric correction IonoCorrection_{L1L5},

a determination step E4, implemented by the determining module 5, comprising determining the usable residual ionospheric error IonoResidual for each of the at least five satellites,

a determination step E5, implemented by the determining module 6, comprising determining the usable standard deviation o for each of the at least five satellites from at least the usable residual ionospheric error IonoResidual,

a step E6 of guidance of the aircraft AC, implemented by the guiding module 7, comprising guiding the aircraft AC from the usable pseudo-ranges PR of each of the at least five satellites and the usable standard deviations σ of each of the at least five satellites.

According to one embodiment, the step E6 of guidance of the aircraft AC comprises the following substeps:

a determination substep E61, implemented by the determining submodule 71, comprising determining the navigation information PVT of the aircraft AC from the usable pseudo-range PR of each of the at least five satellites and the usable standard deviation σ of each of the at least five satellites,

a determination substep E62, implemented by the determining submodule 72, comprising determining a trajectory deviation from an approach segment and navigation information PVT,

a guidance substep E63, implemented by the guiding submodule 73, comprising guiding the aircraft AC from the trajectory deviation and guidance and control laws.

The guidance method also comprises a monitoring step E7, implemented by the monitoring module 8, comprising monitoring the integrity of the navigation information PVT.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for guiding an aircraft in an approach procedure with a view to landing on a landing runway, using a satellite geopositioning system comprising a set of satellites, comprising the following steps implemented iteratively onboard the aircraft:
receiving, implemented by a receiving module, comprising receiving at least one first signal carried by a first frequency and sent by at least five satellites of the geopositioning system and at least one second signal carried by a second frequency and sent by each of the at least five satellites, the first signal comprising at least one item of information representative of a first pseudo-range measured by each of the at least five satellites, the second signal comprising at least one item of information representative of a second pseudo-range measured by each of the at least five satellites,
a first determining, implemented by a first determining module, comprising determining a first ionospheric correction for each of the at least five satellites from the first pseudo-range and from the second pseudo-range measured by each of the at least five satellites,
a second determining, implemented by a second determining module, comprising determining a usable pseudo-range for each of the at least five satellites from at least the first measured pseudo-range and the first ionospheric correction,
a third determining, implemented by a third determining module, comprising determining a residual ionospheric error that can be used for each of the at least five satellites, the usable residual ionospheric error being equal to a sum of a first residual ionospheric error and of an absolute value of a difference between an ionospheric correction originating from an atmospheric model and from the first ionospheric correction,
a fourth determining, implemented by a fourth determining module, comprising determining a usable standard deviation for each of the at least five satellites from at least the usable residual ionospheric error,
guiding the aircraft, implemented by a guiding module, comprising guiding the aircraft from the usable pseudo-range of each of the at least five satellites and from the usable standard deviation of each of the at least five satellites.

2. The method according to claim 1, wherein the step of guidance of the aircraft comprises the following substeps:
a first determining substep implemented by a first determination submodule, comprising determining navigation information of the aircraft from the usable pseudo-range of each of the at least five satellites and the usable standard deviation of each of the at least five satellites,
a second determining substep, implemented by a second determination submodule, comprising determining a trajectory deviation from an approach segment and the navigation information,
a guiding substep, implemented by a guidance submodule, comprising guiding the aircraft from the trajectory deviation and guidance and control laws.

3. The method according to claim 1, wherein, in the first determining substep, the first ionospheric correction IonoCorrection_{L1L5} expressed in meters is determined from the following expression:
$${IonoCorrection}_{L 1 L 5} = \frac{RAW \_ {PR}_{L 5} - {γ}_{L 1 L 5} RAW \_ {PR}_{L 1}}{1 - {γ}_{L 1 L 5}}$$
in which:
RAW_PR_{L1} corresponds to the first measured pseudo-range expressed in meters,
RAW_PR_{L5} corresponds to the second measured pseudo-range expressed in meters,
γ_{L1L5} corresponds to a predetermined constant.

4. The method according to claim 1,
wherein the first signal also comprises an item of information representative of a clock correction, and
wherein, in the second determining substep, the usable pseudo-range PR expressed in meters is determined from the following expression:
PR=Smoothed(RAW_PR_{L1})+TropoCorrection+ClockCorrection+IonoCorrection_{L1L5}
in which:
Smoothed(RAW_PR_{L1}) corresponds to the first pseudo-range smoothed by the second determining module expressed in meters,
TropoCorrection corresponds to a tropospheric correction expressed in meters determined by the second determining module,
ClockCorrection corresponds to the clock correction expressed in meters,
IonoCorrection_{L1L5} corresponds to the first ionospheric correction expressed in meters.

5. The method according to claim 1,
wherein the first signal also comprises an item of information representative of an elevation angle of one of the five satellites sending the first signal, and
wherein, in the third determining step, the first residual ionospheric error IonoResidual_{L1L5} expressed in meters is determined from the following expression:
$$Iono {Residual}_{L 1 L 5} = \frac{40}{261 + {EL}^{2}} + 0.018$$
in which:
EL corresponds to the elevation angle of the one satellite expressed in degrees.

6. The method according to claim 1, wherein the first signal also comprises an item of information representative of a residual positioning error of the satellite sending the first signal, and
wherein, in the fourth determining step, the usable standard deviation o expressed in meters is determined from the following expression:
$$σ = \sqrt{{URA}^{2} + {TropoResidual}^{2} + {IonoResidual}^{2} + {AirBorneReceiverResidual}^{2}}$$
in which:
URA corresponds to the residual positioning error expressed in meters,
TropoResidual corresponds to a residual tropospheric error expressed in meters determined by the fourth determining module,
IonoResidual corresponds to the usable residual ionospheric error expressed in meters determined in the third determining step,
AirBorneReceiverResidual corresponds to a residual thermal noise error expressed in meters.

7. The method according to claim 1, further comprising the step:
monitoring, implemented by a monitoring module, comprising monitoring an integrity of the information received from the satellites.

8. The method according to claim 1,
wherein the first frequency carrying the first signal has a value of between 1500 MHz and 1600 MHz, and
wherein the second frequency carrying the second signal has a value of between 1170 MHz and 1180 MHz.

9. An embedded system of an aircraft for guidance of the aircraft in an approach procedure with a view to landing on a landing runway, using a satellite geopositioning system comprising a set of satellites, comprising the following modules:
a receiving module configured to receive at least one first signal carried by a first frequency and sent by at least five satellites of the geopositioning system and at least one second signal carried by a second frequency and sent by each of the at least five satellites, the first signal comprising at least one item of information representative of a first pseudo-range measured by each of the at least five satellites, the second signal comprising at least one item of information representative of a second pseudo-range measured by each of the at least five satellites,
a first determining module configured to determine a first ionospheric correction for each of the at least five satellites from the first pseudo-range and the second pseudo-range measured by each of the at least five satellites,
a second determining module configured to determine a usable pseudo-range for each of the at least five satellites from at least the first measured pseudo-range and the first ionospheric correction,
a third determining module configured to determine a usable residual ionospheric error for each of the at least five satellites, the usable residual ionospheric error being equal to a sum of a first residual ionospheric error and an absolute value of a difference between an ionospheric correction originating from an atmospheric module and the first ionospheric correction,
a fourth determining module configured to determine a usable standard deviation for each of the at least five satellites from at least the usable residual ionospheric error,
a guiding module configured to guide the aircraft from the usable pseudo-range of each of the at least five satellites and the usable standard deviation of each of the at least five satellites.

10. The embedded system according to claim 9, wherein the guiding module comprises:
a first determination submodule configured to determine navigation information of the aircraft from the usable pseudo-range of each of the at least five satellites and the usable standard deviation of each of the at least five satellites,
a second determination submodule configured to determine a trajectory deviation from an approach segment and the navigation information,
a guidance submodule configured to guide the aircraft from the trajectory deviation and guidance and control laws.

11. The embedded system according to claim 9, further comprising a monitoring module configured to monitor the integrity of the navigation information.

12. An aircraft, comprising:
a guidance system of an aircraft in an approach procedure with a view to landing on a landing runway, using a satellite geopositioning system comprising a set of satellites, in accordance with claim 9.
